(19) United States
(12) Patent Application Publication
(10) Pub. No.: US 2012/0313793 A1
(43) Pub. Date: Dec. 13, 2012

(54) TRUCK MOUNTED STOP LIGHT DISPLAY

(76) Inventor: Dustin Colin Huguenot, Morgantown, KY (US)

(21) Appl. No.: 13/491,576

(22) Filed: Jun. 7, 2012

Related U.S. Application Data
(60) Provisional application No. 61/494,269, filed on Jun. 7, 2011.

(51) Int. Cl. G08G 1/095

(52) U.S. Cl. 340/908

(57) ABSTRACT

A stop light can be mounted on the rear end of a large vehicle, such as a truck trailer, to relay/repeat a traffic signal indicator toward which the vehicle is approaching or passing through. The stop light provides a mechanism for vehicles traveling behind the large vehicle to know the status of the stop light and make a determination whether to go through an intersection along with the large vehicle, or to slow down for a changing light. Typically, drivers of these following vehicles cannot see a stop light until after the larger lead vehicle passes through an intersection, which can be too late to slow down or stop before entering the intersection. The truck-mounted stop light can make crossing intersections much safer, where a driver can know what to expect before the driver actually gets up to the light.

### CROSS-REFERENCE TO RELATED APPLICATIONS

This application claims the benefit of priority of U.S. provisional patent No. 61/494,269, filed Jun. 7, 2011, the contents of which are herein incorporated by reference.

### BACKGROUND OF THE INVENTION

The present invention relates to traffic signals and, more particularly, to a truck mounted stop light display for relaying stop light status to a back of a vehicle that may block view of the street mounted stop light.

When following behind a semi truck and trailer, a passenger vehicle may be visually blocked from seeing a traffic signal until the truck passes through the intersection. At some speeds, it may be too late for the passenger vehicle to stop without entering the intersection. This situation can be dangerous. This situation can be worse when multiple trucks are behind one another in traffic.

As can be seen, there is a need for a method and apparatus for providing traffic signal information to vehicle behind tall vehicles, such as semi trucks and trailers.

### SUMMARY OF THE INVENTION

In one aspect of the present invention, a vehicle mounted stoplight display system comprises a sensor unit adapted to detect a status of a traffic signal; and a stoplight display unit disposed on a back side of a vehicle, the stoplight display unit having a red light, a yellow light and a green light, wherein the stoplight display unit receives a signal from the sensor unit to illuminate one of the red light, the yellow light and the green light corresponding to the status of the traffic signal.

In another aspect of the present invention, a traffic signal relay system comprises a sensor unit adapted to detect a status of a traffic signal; a stoplight display unit disposed on a back side of a vehicle, the stoplight display unit having a red light, a yellow light and a green light; either a transmitter/receiver in the stoplight display unit operable to receive a wireless signal from the sensor unit, or a first wire connection in the stoplight display unit and a second wire connection in the sensor unit, the first and second wire connections electrically connected to provide an electrical connection between the stoplight display unit and the sensor unit, wherein the stoplight display unit receives a signal from the sensor unit to illuminate one of the red light, the yellow light and the green light corresponding to the status of the traffic signal, and the status of the traffic signal is selected from red light illuminated, yellow light illuminated, green light illuminated, yellow light flashing, and red light flashing.

These and other features, aspects and advantages of the present invention will become better understood with reference to the following drawings, description and claims.

### BRIEF DESCRIPTION OF THE DRAWINGS

FIG. 1 is a rear perspective view of a truck trailer having a truck-mounted stop light according to an exemplary embodiment of the present invention;

FIG. 2 is a side perspective view of a truck and a portion of its trailer, showing a sensor unit used to detect stop light status, according to an exemplary embodiment of the present invention;

FIG. 3 is a front view of the sensor unit of FIG. 2;

FIG. 4 is a side view of the sensor unit of FIG. 2;

FIG. 5 is a front perspective view of the truck-mounted stop light of FIG. 1; and

FIG. 6 is a rear perspective view of the truck-mounted stop light of FIG. 1.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a stop light that can be mounted on the rear end of a large vehicle, such as a truck trailer, that relays/repeats a traffic signal indicator toward which the vehicle is approaching or passing through. The stop light provides a mechanism for vehicles traveling behind the large vehicle to know the status of the stop light and make a determination whether to go through an intersection along with the large vehicle, or to slow down for a changing light. Typically, drivers of these following vehicles cannot see a stop light until after the larger lead vehicle passes through an intersection, which can be too late to slow down or stop before entering the intersection. The truck-mounted stop light can make crossing intersections much safer, where a driver can know what to expect before the driver actually gets up to the light.

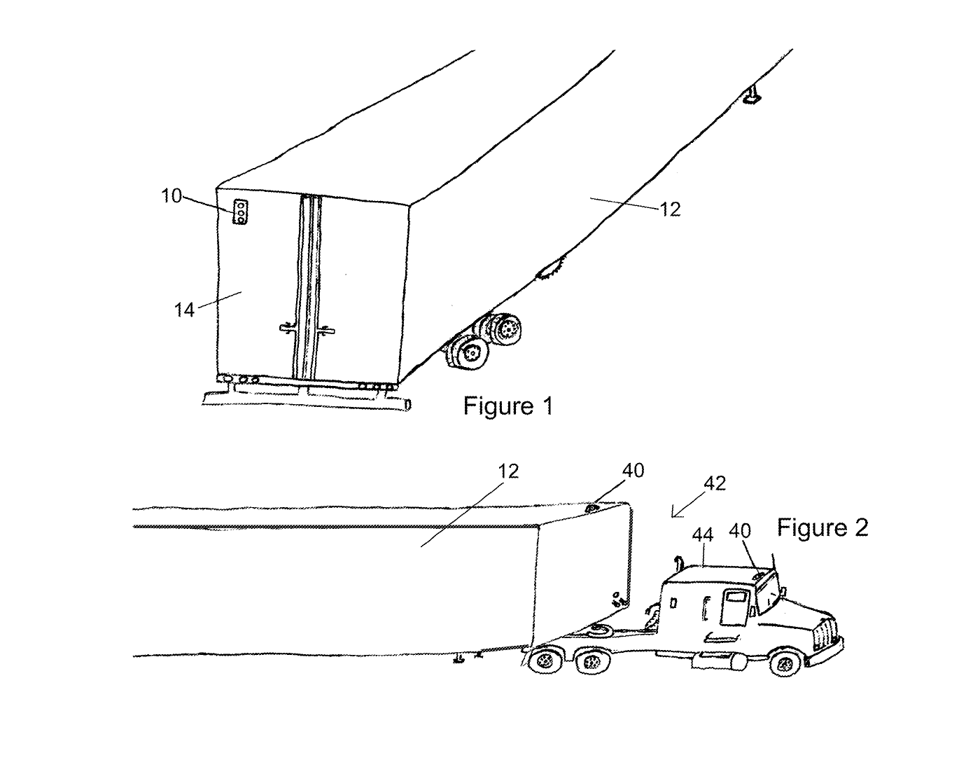

Referring to FIGS. 1, 5 and 6, a stoplight display unit 10 is adapted to be mounted on a rear side 14 of a large vehicle, such as a truck trailer 12. The stoplight display unit 10 can include a green light 16, a yellow light 18, and a red light 20, the lights 16, 18, 20 can be arranged similarly to a standard stoplight. The lights 16, 18, 20, can be standard lights with colored lens or colored lights, for example. The lights 16, 18, 20 can be various styles, such as light emitting diodes (LEDs).

The stoplight display unit 10 can be a sealed, integral unit or may be formed in a housing 30 that can be joined together with screws 22. The back side 32 of the stoplight display unit 10 can have mounting brackets 24 operable to mount the stoplight display unit 10 to the truck trailer 12. The mounting brackets 24 can be of various styles and designs, such as brackets, clips, straps, magnets, bolts or the like.

A battery/transmitter/receiver compartment 26 may house batteries for a battery powered stoplight display unit 10 and may also house a transmitter/receiver for communicating with a sensor unit 40 (or directly with a stoplight), as described below.

Wired power connections 28 may be provided on the back side 32 of the stoplight display unit 10 to connect power to the unit 10 or to connect the unit 10 to the sensor unit 40. With a wired version, the battery/transmitter/receiver compartment 26 may not be needed, depending on the application.

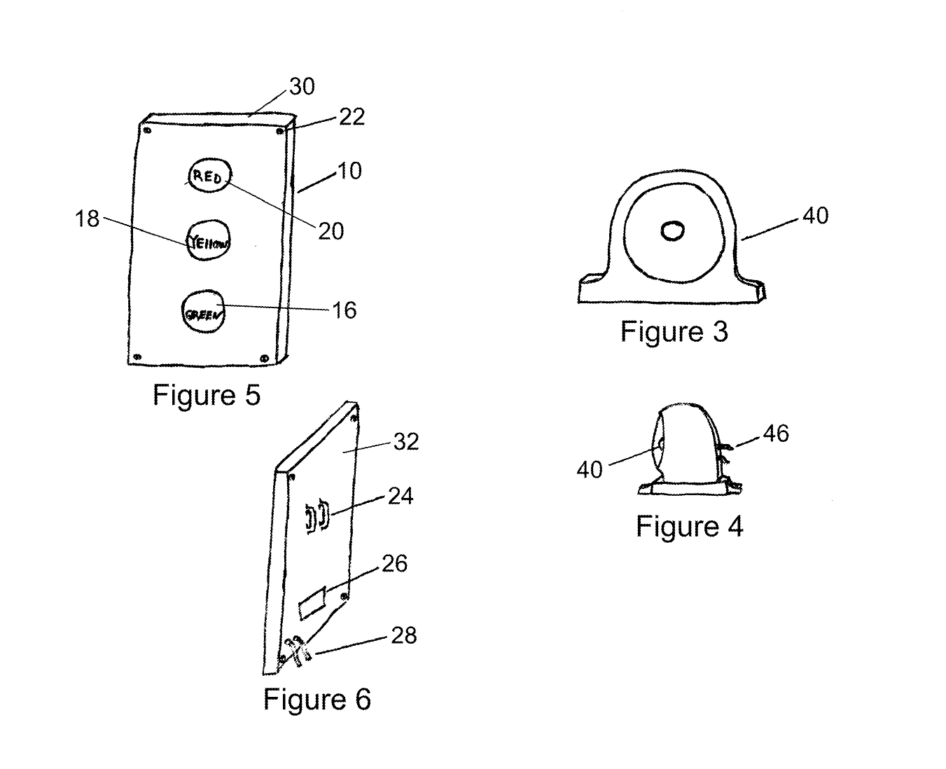

Referring now to FIGS. 2, 3 and 4, the sensor unit 40 can be disposed at various locations on a large vehicle 42. For example, the sensor unit 40 can be mounted at the top of a truck cab 44 or at the top of the truck trailer 12. The sensor unit 40 can include wire connections 46 to connect a wire from the sensor unit 40 to the stoplight display unit 10. In some embodiments, the sensor unit 40 may wirelessly transmit a signal to the stoplight display unit 10.

The sensor unit 40 may be adapted to detect and determine a status of a traffic signal (also referred to as a street stoplight), the status being red light illuminated, yellow light illuminated, green light illuminated, yellow flashing, or red flashing. The sensor unit 40 can include various mechanisms to detect the status of the traffic signal, such as an optic lens, a laser, a camera, or the like. The sensor unit 40 can relay this status indication to the stoplight display unit 10 such that the stoplight display unit 10 displays the status of the stoplight on the street. When a vehicle is following the truck trailer 12, the stoplight display unit 10 can show the driver of the vehicle the status of the street stoplight, even when visual view is blocked by the truck trailer 12. In some embodiments, the sensor unit 40 can include an alarm to indicate if the sensor unit 40 is removed beyond a predetermined distance from the stoplight display unit 10.

In some embodiments, street stoplights themselves can be configured to wirelessly transmit status information. In this embodiment, the sensor unit 40 may detect the wireless signal from the street stoplight and illuminate the stoplight display unit 10 accordingly. In some embodiments, the sensor unit 40 may not be needed and the stoplight display unit 10 may be configured to directly receive the wireless signal from the street stoplight, such that the stoplight display unit 10 can be directly synchronized with the street stoplight. In some embodiments, the vehicle 42 can be configured with both configurations—1) to receive wireless information from a street stoplight, and 2) to receive street stoplight status via a sensor unit 40. This way, if a street stoplight is not configured to send a wireless status signal, the stoplight display unit 10 can still function appropriately.

It should be understood, of course, that the foregoing relates to exemplary embodiments of the invention and that modifications may be made without departing from the spirit and scope of the invention as set forth in the following claims.

What is claimed is:

1. A vehicle mounted stoplight display system comprising:
a sensor unit adapted to detect a status of a traffic signal; and
a stoplight display unit disposed on a back side of a vehicle, the stoplight display unit having a red light, a yellow light and a green light, wherein the stoplight display unit receives a signal from the sensor unit to illuminate one of the red light, the yellow light and the green light corresponding to the status of the traffic signal.

2. The vehicle mounted stoplight display system of claim 1, wherein the status of the traffic signal is selected from red light illuminated, yellow light illuminated, green light illuminated, yellow light flashing, and red light flashing.

3. The vehicle mounted stoplight display system of claim 1, wherein the vehicle is a tractor trailer.

4. The vehicle mounted stoplight display system of claim 1, further comprising a transmitter/receiver in the stoplight display unit operable to receive a wireless signal from the sensor unit.

5. The vehicle mounted stoplight display system of claim 1, further comprising a first wire connection in the stoplight display unit and a second wire connection in the sensor unit, the first and second wire connections electrically connected to provide an electrical connection between the stoplight display unit and the sensor unit.

6. The vehicle mounted stoplight display system of claim 1, further comprising a mounting bracket adapted to attach the stoplight display unit to the back side of the vehicle.

7. A traffic signal relay system comprising:
a sensor unit adapted to detect a status of a traffic signal;
a stoplight display unit disposed on a back side of a vehicle, the stoplight display unit having a red light, a yellow light and a green light;
either a transmitter/receiver in the stoplight display unit operable to receive a wireless signal from the sensor unit, or a first wire connection in the stoplight display unit and a second wire connection in the sensor unit, the first and second wire connections electrically connected to provide an electrical connection between the stoplight display unit and the sensor unit, wherein
the stoplight display unit receives a signal from the sensor unit to illuminate one of the red light, the yellow light and the green light corresponding to the status of the traffic signal, and
the status of the traffic signal is selected from red light illuminated, yellow light illuminated, green light illuminated, yellow light flashing, and red light flashing.

8. The traffic signal relay system of claim 7, wherein the vehicle is a tractor trailer.

9. The traffic signal relay system of claim 7, further comprising a mounting bracket adapted to attach the stoplight display unit to the back side of the vehicle.

10. The traffic signal relay system of claim 7, wherein at least one of the sensor unit and the stoplight display unit are operable to receive a wireless signal from the traffic signal, the wireless signal including the status of the traffic signal.
